(19) United States
(12) Patent Application Publication
(10) Pub. No.: US 2021/0129268 A1
(43) Pub. Date: May 6, 2021

(54) LASER METAL DEPOSITION WITH CORED FILLER WIRE

(71) Applicant: Siemens Energy, Inc., Orlando, FL (US)

(72) Inventors: Bernd Burbaum, Falkensee (DE); Ahmed Kamel, Orlando, FL (US)

(21) Appl. No.: 16/638,659

(22) PCT Filed: Aug. 15, 2017
(86) PCT No.: PCT/US2017/046942

§ 371 Date: Feb. 12, 2020

(51) Int. Cl. B23K 26/342; B23K 35/30; B23K 1/005; B23K 1/00; B23K 26/00; F01D 5/00; B29C 64/118; B29C 64/268; B29C 64/188

(52) U.S. Cl. CPC B23K 26/342; B23K 35/3033; B23K 1/0056; B23K 1/0018; B33Y 10/00; F01D 5/005; B29C 64/118; B29C 64/268; B29C 64/188; B23K 26/0093

(57) ABSTRACT

A cored filler wire (10) used in a laser metal deposition (LMD) process and method of using the same. The cored filler wire includes an outer shell (12) surrounding an inner filler material (14). The outer shell is formed from a first material, e.g., a nickel based alloy having a low gamma prime content. The inner filler comprises at least a second material, e.g., a nickel based superalloy powder material comprising a gamma prime content higher than the first material. Upon laser processing, via LMD, and subsequent solidification, the resulting build-up layer (18) formed from the processed cored filler wire comprises an identical or near identical chemical composition to that of the underlying base material (5) or component being repaired.

### TECHNICAL FIELD

The present disclosure relates generally to the field of materials technology, and more particularly to additive manufacturing and repair methods of laser metal deposition using cored filler wires.

### BACKGROUND

Weld repair of superalloys presents a variety of technical challenges because of the high strength (and corresponding low ductility) that these alloys are optimized to achieve. Heat sources such as lasers and arcs are being applied to build additively manufactured parts or repair damaged superalloy components. One type of process used for additive manufacturing or repair is a laser metal deposition (LMD) process. LMD processes utilize powdered materials that are deposited into a melt pool to form layers of an additive material, also known as build-up layer. Unfortunately, LMD processes using powdered materials are not efficient due to the amount of materials lost during the spraying process, e.g., deposits that fail to enter the melt pool for processing. Additionally, due to the unconfined nature of powdered materials, contaminants may often result end up being deposited along with the powdered materials during the LMD process. Therefore, a need remains for a more efficient LMD process, which at least reduces the loss of any materials during the LMD process, and which reduces or eliminates any contaminants associated with traditional powdered depositions.

### SUMMARY

It should be appreciated that the present inventor has recognized the above limitations, and now discloses a new cored filler wire for use during laser metal deposition processes. Although nickel-based superalloys with high gamma prime (y′) content cannot be, fabricated or forged as a wire, the present have developed embodiments of a cored filler wire where the outer shell or casing comprises a low y′ content, which can be forged and defines an interior portion, and the interior portion may now be filled with a high y′ content superalloy material, e.g., nickel-based superalloys, in powdered form.

In one exemplary embodiment, a cored filler wire for use in a laser metal deposition (LMD) process is provided. The cored filler wire may include at least an outer shell formed from a first material and surrounding an inner portion (or inner filler material) formed from at least a second material different from the first material. In an embodiment where the cored filler wire is a nickel based superalloy cored filler wire, the outer shell (first material) may be formed from a nickel base alloy with low gamma prime content, which allows for forging of the outer shell with, e.g., a core inner portion for filling with, e.g., a powdered nickel based superalloy with a higher gamma prime content than the first material. Additionally or alternatively, a braze metal alloy powder may be mixed or combined with the powdered nickel based superalloy material to achieve a self-healing effect, e.g., during brazing or post-braze treatment.

In another exemplary embodiment, a laser metal deposition process using a cored filler wire is provided. The method includes applying a laser energy, e.g., from an LMD system, to a surface of a base material or component to form a melt pool thereon. The method also includes depositing or feeding the cored filler wire into the melt pool for melting with the laser energy during the LMD process. Upon solidification of the melted portions of the base material and cored filler wire, a build-up layer of additive materials is formed on the base material. The method further includes repeating the melting, depositing, and solidification steps until a desired component or product is achieved. Additionally or alternatively, the method may include brazing the desired component and subjecting the component to post-braze heat treatment. The method may further include non-destructive testing (NDT) of the desired component, e.g., via digital infrared thermography, dye penetrant, ultrasonic inspection, or by other means known in the art for NDT of, e.g., industrial components.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1A illustrates a perspective view of a cross-section of an exemplary embodiment of a laser metal deposition (LMD) cored filler wire, in accordance with the disclosure provided herein;

FIG. 1B illustrates a second perspective view of the LMD cored filler wire of FIG. 1A, in accordance with the disclosure provided herein;

FIG. 2 schematically illustrates an exemplary embodiment of an LMD process with an embodiment of the LMD cored filler wire of FIG. 1, in accordance with the disclosure provided herein; and

FIG. 3 illustrates a block diagram of an LMD additive manufacturing and repair method with a cored filler wire, in accordance with the disclosure provided herein.

### DETAILED DESCRIPTION

The components and materials described hereinafter as making up the various embodiments are intended to be illustrative and not restrictive. Many suitable components and materials that would perform the same or a similar function as the materials described herein are intended to be embraced within the scope of embodiments of the present invention.

The present inventors have developed a novel additive manufacturing (AM) and/or repair method that involves, e.g., a laser metal deposition (LMD) process with a cored filler wire. Use of the disclosed wire technology with the LMD process reduces contaminations common with powdered particles and allows for structural repair of superalloy materials, as the novel cored filler wire, once processed, provides for an identical or near identical chemical composition as the base material or underlying component. Additionally, the inventors' novel cored filler wire provides for increased efficiency during the LMD process, as the cored filler wire now allows for a complete deposit of the additive materials to be fed into the melt pool, as the cored filler wire a confined space for the deposit. The novel cored filler wire further allows for repair technology for hard weldable metals, e.g., gas turbine blades, vanes or other hard weldable nickel based superalloys. It should further be appreciated that use of the cored filler wire also provides for a more complete 3D-printing application, as overhead LMD is now possible with a confined deposit, such as the novel cored filler wire. Rapid prototyping processes are also now possible via LMD with the inventors' cored filler wire.

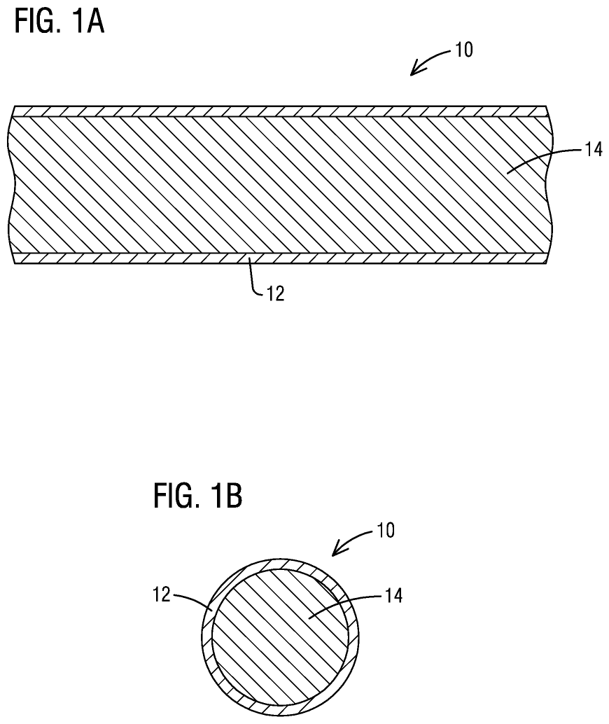

Referring now to the drawings wherein the showings are for purposes of illustrating embodiments of the subject matter herein only and not for limiting the same, FIGS. 1A and 1B illustrate perspective views of an exemplary embodiment of a laser metal deposition (LMD) cored filler wire (cored wire) 10.

As shown in FIGS. 1A and 1B, the cored wire 10 may be comprised of at least an outer shell or casing 12 surrounding an interior portion of the cored wire 10, i.e., an inner filler 14. The cored wire 10 may be comprised of at least two different materials, with the outer shell 12 comprising at least a first material comprised of a base alloy material, which may include the same or similar materials forming the base material 5. The outer shell 12 surrounds the inner filler 14 which may include at least a second material different from the first material, and which may include the same or similar materials forming the base material 5.

For example, in an embodiment where the cored wire 10 is comprised of a nickel based superalloy with high gamma prime (y′) content and a braze alloy that may be used for high temperature brazing, the outer shell 12 may be made from, e.g., a low gamma prime y′ nickel based alloy, which may be used for high temperature brazing as a powder or foil, e.g., DF-4B. The inner filler 14 may be made from, e.g., a powder comprised of a nickel based superalloy with high y′ content, e.g., like Alloy247 and Rene80.

It should be appreciated that the y′ content of the outer shell 12 materials is lower than the y′ content of inner filler materials 14 due in part to the difficulties associated with forging, e.g., nickel alloy materials with high y′ content. The lower y′ content allows for forging of the outer shell 12 with a defined interior portion (core). The differences in y′ content also results in the cored wire 10 being formed from at least two different materials, as the composition of the outer shell 12 with low y′ content differs from the composition of the inner filler 14 with high y′ content. Additionally or alternatively, the inner filler 14 may be comprised of a mixture or combination of a powdered braze alloy material with the powdered nickel based superalloy with high y′ content. It should be appreciated that the braze alloy material comprised in the inner filler 14 may allow for a self-healing effect during any subsequent braze operation or post weld heat treatment.

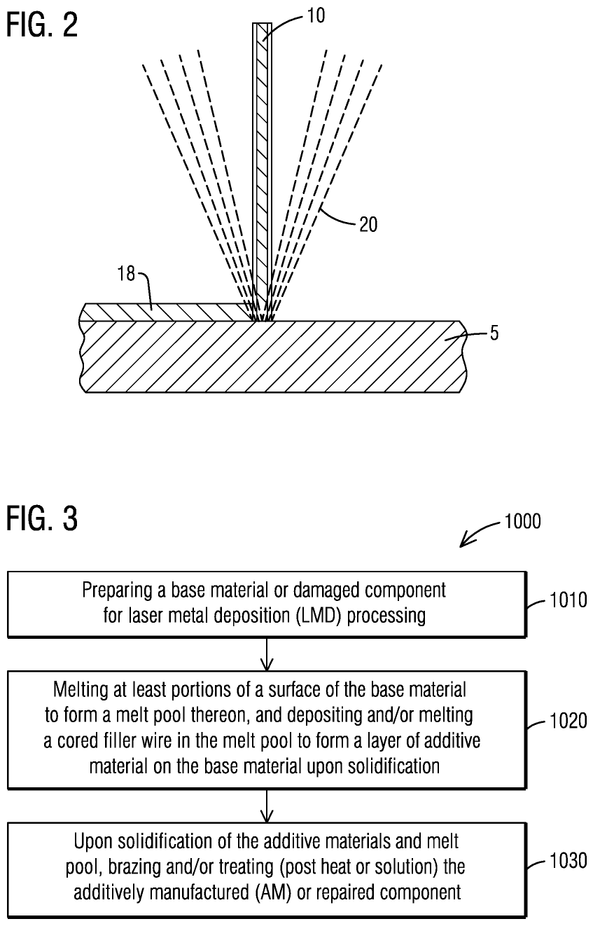

With continued reference to the figures, and now FIGS. 2 and 3, an embodiment of an LMD process (method) 1000 using embodiments of the cored wire 10 is provided. It should be appreciated that any method steps disclosed herein are not required to be performed in any particular order, and are hereby provided for exemplary purposes.

For laser processing of the cord wire 10 to form a desired component, an LMD system may be provided for performing the disclosed method 1000. The LMD system may include at least an energy source operably configured to emit laser energy, e.g., a laser beam 20 (continuous and/or pulsed), therefrom and towards, e.g., a surface of a base material 5, component, or solidified layer of additive materials 18, for melting portions of the base material 5 to form a melt pool thereon, and for melting the cored wire 10 therein to form layers of the additive (build-up) materials 18 upon solidification of the melted portions. Additionally or alternatively, the LMD system may include a feed tool (not shown) operably connected to the laser energy source or approximately thereto, for feeding and/or depositing the core wire 10 towards the base material 5 and/or into the melt pool for laser processing. The tool may be operatively connected to the laser energy source and/or a controller for controlling the deposition or feeding of the cored wire 10 into the melted portions of the base material. The controller may also be operably configured to control the intensity (heat temperature) of the laser energy and feed rate of the core wire 10.

With continued reference to the figures, the method 1000 may include preparing a base material 5 or other component for laser processing via the LMD system (1010). Preparing the base material 5 or component for LMD processing may include, e.g., removing the component (damaged or otherwise) from an industrial machine, e.g., a turbo machine engine. The preparing steps may also include removing any damaged portions from the component and pre-heat and/or solution treating the component prior to beginning the LMD process. The damaged portions may be removed by grinding, milling, or other means for removing damaged portions of a superalloy component known in the art. Upon removing any undesired portions from the component, the component may be placed or removably secured to, e.g., a platform (not shown) or other type of securing means in, e.g., a chamber or other defined work area, for build-up and/or repair via LMD process with embodiment of the cored wire 10.

Upon securing the base material 5, the method 1000 may include applying a laser energy 20, via the LMD system, to form a build-up of additive materials 18 on the base material 5 from the cored wire 10 (1020). In this step, one or more laser beams 20 may be emitted from one or more laser sources of the LMD system, consecutively or simultaneously, towards the base material 5 to form a melt pool thereon and for depositing and melting the cored wire 10 therein. Upon forming the melt pool, the cored wire 10 may be deposited or fed into the melt pool, e.g., via a gripping device, power feed system, or other means in the art for depositing or feeding a forged wire, and melted via laser energy to form one or more layers of additive (build-up) materials 18 on the base material 5 upon solidification. It should be appreciated that, during LMD processing, the cored filler wire may be melted and metallurgically bonded to the base material with, e.g., the laser beam.

Additionally or alternatively, the melt pool may be protected by a shielding gas, e.g., argon, helium or mixtures thereof, which may be applied via the LMD system or a shielding system operably connected thereto for protecting the melt pool and/or deposit from contaminants.

In an embodiment where the inner filler 14 comprises a combination or mixture of, e.g., the base superalloy material and braze alloy material, the mixture of the base alloy and the braze alloy powder can be verified layer-wise, and the depositing and laser processing steps may be repeated until a shape and/or geometry of a desired component is achieved. It should be appreciated that a full metallurgical bonding and a self-healing of solidification cracks (hot cracks) during the LMD process may also be achieved during the subsequent or final brazing and/or a post weld heat treatment process due in part to the braze alloy mixture comprised in the inner filler 14.

With continued reference to the figures, and upon solidification of the melted portions and achieving a desired part or component, the method 1000 may include high temperature brazing, e.g., via torch brazing, furnace brazing, etc., of the desired component (1030). It should be appreciated that during the subsequent high temperature brazing process 1030, the braze alloy mixture in the inner filler 14 may cause a self-healing of the desired component. It should further be appreciated that additively manufacturing or repairing a component 5 via the inventors' novel LMD process with cored filler wire 10 allows for structural repair of components by using base alloy materials that are the same material as the base material of the component. That is, the LMD process allows for repair of the component with materials (additive materials) having, e.g., an identical or near identical composition as the underlying (base) substrate 5.

The method 1000 may further include repeating any of the steps 1010-1030 until the desired component is achieved. Once the desired component has been achieved via the LMD process with cored wire 10, the method may include steps for finishing the desired component, which may include machining or otherwise removing any undesired waste remaining from the LMD or brazing operation, and commencing any post weld treatments, e.g., post heat or solution treatment, prior to providing the component for operation in, e.g., an industrial machine. It should be appreciated that testing of the structural integrity of the component may also be desired and provided as an addition method 1000 step prior to using the desired component in its normal course of operation.

It should be appreciated that aspects of the exemplary LMD system disclose herein may be implemented by any appropriate processor system using any appropriate programming language or programming technique. The system can take the form of any appropriate circuitry, such as may involve a hardware embodiment, a software embodiment or an embodiment comprising both hardware and software elements. In one embodiment, the system may be implemented by way of software and hardware (e.g., processor, sensors, etc), which may include but is not limited to firmware, resident software, microcode, etc.

Furthermore, parts of the processor system can take the form of a computer program product accessible from a processor-usable or processor-readable medium providing program code for use by or in connection with a processor or any instruction execution system. Examples of processor-readable media may include non-transitory tangible processor-readable media, such as a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

1. A laser metal deposition (LMD) cored filler wire (10) comprising:
an outer shell (12) defining a cored inner portion (14), wherein the outer shell is formed from a first material, and wherein the cored inner portion comprises at least a second material different from the first material.

2. The cored filler wire of claim 1, wherein the cored filler wire is a nickel based superalloy cored filler wire, and wherein the first material comprises a nickel based alloy and wherein the second material comprises a powdered nickel based superalloy having a different gamma prime (y′) than the nickel based alloy of the first material.

3. The cored filler wire of claim 2, wherein the nickel based alloy of the first material comprises a low y′ content and wherein the nickel based superalloy of the second material comprises a higher y′ content than the first material.

4. The cored filler wire of claim 2, wherein the second material further comprises a powder braze metal alloy mixed with the powdered nickel based superalloy.

5. An additive manufacturing or repair method comprising:
preparing a base material substrate (5) (BMS) for laser metal deposition (LMD) processing;
melting portions of the BMS to form a melt pool thereon;
depositing or feeding a cored filler wire according to claim 1 into the melt pool and melting the cored filler wire to form a build-up layer of additive material (18) on the BMS upon solidification of the melted portions.

6. The method of claim 5, wherein the cored filler wire is a nickel based superalloy cored filler wire, and wherein the first material comprises a nickel based alloy and wherein the second material comprises a powdered nickel based superalloy having a different gamma prime (y′) than the nickel based alloy of the first material.

7. The method of claim 6, wherein the nickel based alloy of the first material comprises a low y′ content and wherein the nickel based superalloy of the second material comprises a higher y′ content than the first material.

8. The method of claim 6, wherein the second material further comprises a powder braze metal alloy mixed with the powdered nickel based superalloy.

9. The method of claim 5 further comprising:
repeating the melting and depositing steps until a desired component is achieved.

10. The method of claim 5 further comprising:
brazing the desired component; and
finishing the desired component via one or more of a grinding, milling, and post-weld treatment prior to placing the desired component in operation.

11. The cored filler wire of claim 3, wherein the second material further comprises a powder braze metal alloy mixed with the powdered nickel based superalloy.

12. The method of claim 7, wherein the second material further comprises a powder braze metal alloy mixed with the powdered nickel based superalloy.

13. The method of claim 9, further comprising:
brazing the desired component; and
finishing the desired component via one or more of a grinding, milling, and post-weld treatment prior to placing the desired component in operation.
